(19) United States
(12) Patent Application Publication
(10) Pub. No.: US 2011/0079242 A1
(43) Pub. Date: Apr. 7, 2011

(54) PLASMA CLEANING OF WIRE STRANDS

(76) Inventor: Werner REISS, Bad Feilnbach (DE)

(21) Appl. No.: 12/574,728

(22) Filed: Oct. 7, 2009

(51) Int. Cl. B08B 6/00; C23F 1/00

(52) U.S. Cl. 134/1.1; 216/67

(57) ABSTRACT

Methods and apparatus for cleaning impurities, such as oxides, from wire stands using a plasma gas.

### FIELD OF THE INVENTION

The present invention relates to methods cleaning and apparatus for cleaning wire strands, and particularly copper wire strands.

### BACKGROUND OF THE INVENTION

Wire strands are used for a great number of electrical power supply and cable purposes. While gold, aluminum and silver are used to some extent for these purposes, copper wire is the predominant material used. Wire having a diameter of 200 microns up to 8 millimeters is used for a variety of applications.

One problem with wire strands and particularly with copper wire strands is that the wire quickly and easily becomes oxidized. Oxide contamination or layers that form on the wire strands can hinder the adhesion of cover layers and increase contact resistance. Therefore, the wire is normally treated prior to any bonding or soldering to remove the oxide contamination. The most common method of treatment to remove oxides is to clean the wire strand with flux. Flux is a very aggressive chemical and evaporates during surface activation and the flux exhaust created by such evaporation is poisonous. Therefore, wire cleaning operators must wear special protective safety gear and that the cleaning operation requires expensive and complicated safety equipment e.g. exhaust systems, filters, etc.

Therefore there remains a need in the art for improvements to cleaning wire strands prior to a bonding or soldering process.

### SUMMARY OF THE INVENTION

The present invention is provides improved wire cleaning methods wherein the disadvantages associated prior art are avoided. The present invention provides an apparatus and method employing a plasma gas to clean the wire strands.

### BRIEF DESCRIPTION OF THE DRAWINGS

FIG. 1 is a schematic drawing of wire strand cleaning apparatus in accordance with one embodiment of the present invention.

### DETAILED DESCRIPTION OF THE INVENTION

The present invention provides improved wire cleaning methods wherein the disadvantages caused by prior art methods of cleaning wire strands are overcome. In particular, the present invention provides methods and apparatus for cleaning wire strands using a plasma gas.

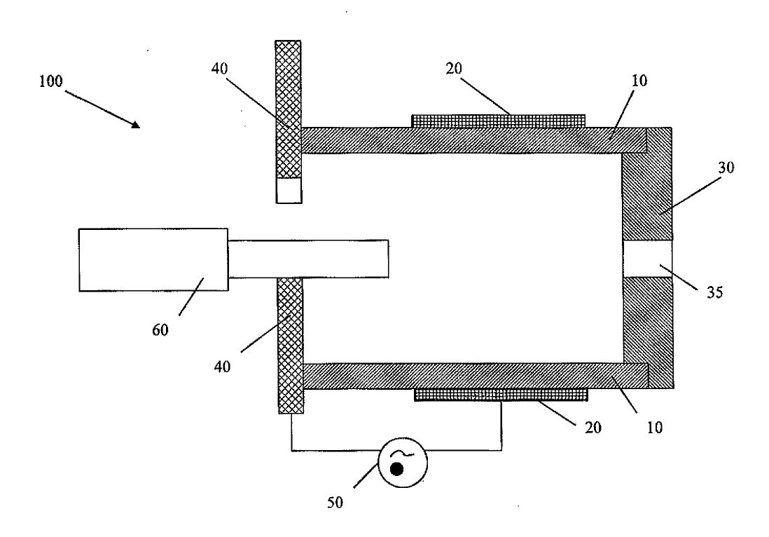

The present invention will be described with reference to FIG. 1 which is a schematic drawing of a wire stand cleaning apparatus according to the present invention. In particular, FIG. 1 shows the system 100, having a hollow chamber, such as a glass tube 10 with a ring electrode 20 in contact with the outer surface of the glass tube 10. The glass tube 10 is also provided with a plug 30 having a gas inlet 35 that seals one end of the glass tube 10. A movable shutter 40 is associated with the other end of the glass tube 10 and is configured to both seal the glass tube 10 when closed and to accommodate a wire strand 60 that is to be cleaned. The shutter 40 is connected through a generator 50 to the ring electrode 20 in order to provide a complete circuit when the system 100 is in operation.

In operation, the wire strand 60 to be cleaned is inserted into the glass tube 10 and accommodated by the shutter 40. The shutter 40 may than be fully closed to both seal the glass tube 10 and to complete the electrical circuit between the wire strand 60 that serves as an anode and the ring electrode that serves as a cathode. A gas for creating a plasma is then provided to the interior of the glass tube 10 through the gas inlet 35 of the plug 30. The generator 50 is used to ignite or excite the gas to form a plasma atmosphere in the glass tube 10. This plasma then acts to clean the wire strand 60 of oxides and other contamination. Once the wire strand 60 is sufficiently cleaned, the glass tube 10 can be evacuated and the clean wire strand 60 can then be further processed or used.

The apparatus and method of the present invention can use any gas that serves the desired purpose, e.g. argon, hydrogen, oxygen, forming gas or mixtures thereof For example oxides can be removed from wires using hydrogen gas, and carbon can be removed using oxygen gas. As a further example, a mixture of 98% argon and 2% hydrogen may be used. As noted above, gold, silver, aluminum and copper wires are commonly used and can all be cleaned using the method of the present invention. In addition, alloy wires can be cleaned using the methods and apparatus of the present invention.

The apparatus and method of the present invention provides several advantages over the prior art wire cleaning methods. In particular, the contaminants, such as oxides can be easily and safely removed from the wire strands. Therefore, adhesion of cover layers for the wire strand can be improved and low contact resistance is maintained. Tight bonds or welds are achieved with wires strands cleaned according to the present invention. The present invention provides a safer alternative for cleaning wire strands than the use of flux as known in the prior art. In particular, by using the methods of the present invention, the use of flux is not necessary and the problems associated with the chemically aggressive nature of flux can be eliminated. Further, because the plasma gas is entirely contained within the glass tube of the system according to the present invention, the method is both operator and environment friendly, i.e. there is no poison exhaust. Therefore, expensive and complicated equipment, such as protective safety gear, and exhaust systems are not necessary when using the present invention.

The system operates in such a way that plasma is generated only during the cleaning process. In particular, as noted, only upon having the shutter closed properly is the electrical circuit necessary for plasma generation complete. Therefore, only when the glass tube is completely sealed is plasma generated.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. A method of cleaning a wire strand comprising exposing the wire strand to a plasma gas.

2. The method of claim 1 wherein the wire strand is made of gold, aluminum, silver, copper or an alloy material.

3. The method of claim 1 wherein the plasma gas is argon, hydrogen, oxygen, forming gas or mixtures thereof.

4. A method of removing impurities from a wire strand comprising subjecting the wire strand to a plasma gas.

5. The method of claim 4 wherein the wire strand is made or gold, aluminum, silver, copper or an alloy material.

6. The method of claim 4 wherein the plasma gas is argon, hydrogen, oxygen, forming gas or mixtures thereof.

7. The method of claim 4 wherein the impurities are oxides or carbon.

8. An apparatus for cleaning wire strands comprising:
a hollow chamber;
a plug sealing a first end of the glass tube and having a gas inlet to allow a gas to be provided to the interior of the glass tube;
a ring electrode in contact with the outer surface of the glass tube;
a movable shutter for sealing a second end of the glass tube and for accommodating the wire strand to be cleaned such that the wire strand extends into the interior of the glass tube; and
a generator connecting the movable shutter and the ring electrode, the generator capable of igniting gas provided to the interior of the glass tube and converting such gas to a plasma;
wherein conversion of the gas to a plasma occurs only when the movable shutter is properly closed to complete an electrical connection between the movable shutter and the ring electrode, such that the wire strand serves as an anode and the ring electrode serves as a cathode.

9. An apparatus according to claim 8 wherein the hollow chamber is a glass tube.

10. The apparatus of claim 8 wherein the wire strand is made of gold, aluminum, silver, copper or an alloy material.

11. The apparatus of claim 11 wherein the gas is argon, hydrogen, oxygen, forming gas or mixtures thereof.
